(19) United States
(12) Patent Application Publication
(10) Pub. No.: US 2026/0128989 A1
(43) Pub. Date: May 7, 2026

(54) METHOD AND APPARATUS FOR ADAPTIVE RETRANSMISSION OF DENM BASED ON 5G NR V2X, AND STORAGE MEDIUM STORING COMPUTER-EXECUTABLE PROGRAM

(71) Applicant: KOREA NATIONAL UNIVERSITY OF TRANSPORTATION INDUSTRY-ACADEMIC COOPERATION FOUNDATION, Chungju-si (KR)

(72) Inventors: Cheol MUN, Yongin-si (KR); Seung Jae YU, Chungju-si (KR)

(21) Appl. No.: 18/966,370

(22) Filed: Dec. 3, 2024

(30) Foreign Application Priority Data
Nov. 6, 2024 (KR) 10-2024-0156297

(51) Int. Cl. H04L 47/12; H04W 4/40; H04W 28/04

(52) U.S. Cl. CPC H04L 47/12; H04W 4/40; H04W 28/04

(57) ABSTRACT

Provided is a method for adaptive retransmission of a DENM based on 5G NR V2X, the method including generating a plurality of aperiodic messages according to message characteristics, calculating channel congestion for the plurality of generated aperiodic messages, determining resources for the plurality of messages based on the channel congestion, and transmitting, to a reception UE, at least one message among the plurality of messages based on the resources.

### CROSS-REFERENCE TO RELATED APPLICATIONS

This application claims the benefit of Korean Patent Application No. 10-2024-0156297, filed on Nov. 6, 2024, which is hereby incorporated by reference as if fully set forth herein.

### BACKGROUND OF THE INVENTION

### Field of the Invention

Embodiments relate to a method and apparatus for adaptive retransmission of a decentralized environmental message (DENM) based on 5G new radio (NR) Vehicle to Everything (V2X), and a storage medium storing a computer-executable program.

### Description of the Related Art

V2X communication technology is recognized as key technology for autonomous driving. 3rd generation partnership project (3GPP) has standardized 5G-based NR V2X technology to support this V2X technology in Rel 16.

In addition, 3GPP has defined a physical (PHY) layer and a medium access control (MAC) layer of NR V2X. In the MAC layer, a MODE 1 resource allocation method that supports uplink and downlink communication between a base station and a user equipment (UE) through a radio access network (RAN) and a MODE 2 resource allocation method for direct communication between UEs through a side-link are defined.

In this case, in a situation where periodic messages and aperiodic messages are mixed and transmitted, there is a problem in that retransmission of the aperiodic messages increases resource reselection and increases the number of resource collisions with the periodic messages, resulting in performance degradation of the periodic messages.

Accordingly, there is increasing interest in resource collisions caused by indiscriminate retransmission of aperiodic messages. However, there is insufficient practical research to reduce these resource collisions.

### SUMMARY OF THE INVENTION

Disclosed embodiments are intended to solve the above-mentioned problems, and provide a method and apparatus for adaptive retransmission of a DENM based on 5G NR V2X, and a storage medium storing a computer-executable program.

Disclosed embodiments provide a hybrid resource reservation scheme that utilizes a dynamic scheduling (DS) scheme for reserving resources for aperiodic messages and a sensing based semi-persistent scheduling (SB-SPS) scheme for reserving resources for periodic messages.

Disclosed embodiments provide an adaptive aperiodic message retransmission scheme that reserves resources by adaptively adjusting the number of retransmissions of an aperiodic message depending on channel congestion.

In accordance with an aspect of the present disclosure, the above and other objects can be accomplished by the provision of a method for adaptive retransmission of a decentralized environmental message (DENM) based on 5G new radio (NR) Vehicle to Everything (V2X), the method including generating a plurality of aperiodic messages according to message characteristics, calculating channel congestion for the plurality of generated aperiodic messages, determining resources for the plurality of messages based on the channel congestion, and transmitting, to a reception user equipment (UE), at least one message among the plurality of messages based on the resources.

The method may further include reserving resources for the plurality of aperiodic messages based on a dynamic scheduling (DS) scheme using a new resource each time a message is generated before the calculating.

The calculating may further include calculating channel congestion of a current channel for the plurality of aperiodic messages a specific number of slots before transmission of a first aperiodic message the among plurality of aperiodic messages.

The determining may include reserving a resource for at least one message among the plurality of messages according to the channel congestion, and canceling resources for remaining messages except for the at least one message among the plurality of messages.

In accordance with another aspect of the present disclosure, there is provided an apparatus for adaptive retransmission of a DENM based on 5G NR V2X, the apparatus including a database configured to store data, and a processor configured to process the data, wherein the processor is configured to generate a plurality of aperiodic messages according to message characteristics, calculate channel congestion for the plurality of generated aperiodic messages, determine resources for the plurality of messages based on the channel congestion, and transmit, to a reception UE, at least one message among the plurality of messages based on the resources.

The processor may reserve resources for the plurality of aperiodic messages based on a DS scheme using a new resource each time a message is generated.

The processor may calculate channel congestion of a current channel for the plurality of aperiodic messages a specific number of slots before transmission of a first aperiodic message among the plurality of aperiodic messages.

The processor may reserve a resource for at least one message among the plurality of messages according to the channel congestion, and cancel resources for remaining messages except for the at least one message among the plurality of messages.

In accordance with a further aspect of the present disclosure, there is provided a storage medium storing a computer-executable program configured to perform steps of generating a plurality of aperiodic messages according to message characteristics, calculating channel congestion for the plurality of generated aperiodic messages, determining resources for the plurality of messages based on the channel congestion, and transmitting, to a reception UE, at least one message among the plurality of messages based on the resources.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram disclosing an example of an adaptive DENM retransmission system according to an embodiment;

FIG. 2 is a diagram disclosing an example of resource reselection for a cooperative awareness message (CAM) using an SB-SPS scheme according to an embodiment;

FIG. 3 is a diagram disclosing an example of resource reselection for a DENM using a DS scheme according to an embodiment;

FIG. 4 is a diagram disclosing an example of a performance graph of the DENM and the CAM based on the number of retransmissions of the DENM according to an embodiment;

FIG. 5 is a diagram disclosing an example of a packet delivery ratio (PDR) performance graph of the DENM and the CAM based on DENM retransmission terminal density according to an embodiment;

FIG. 6 is a diagram disclosing an example of a PDR performance graph of the DENM for adaptive DENM retransmission and fixed DENM retransmission according to an embodiment;

FIG. 7 is a diagram disclosing an example of a PDR performance graph of the CAM for adaptive DENM retransmission and fixed DENM retransmission according to an embodiment;

FIG. 8 is a flowchart disclosing an example of an adaptive DENM retransmission method according to an embodiment;

FIG. 9 is a flowchart disclosing another example of an adaptive DENM retransmission method according to an embodiment; and

FIG. 10 is a diagram disclosing an example of an adaptive DENM retransmission apparatus according to an embodiment.

### DETAILED DESCRIPTION OF THE INVENTION

The present disclosure may have various modifications and embodiments, and specific embodiments are illustrated in the drawings and described in detail.

The various features of the invention disclosed in the claims will be better understood in consideration of the drawings and detailed description. The apparatus, method, process, and various embodiments disclosed in the specification are provided for illustration. The disclosed structural and functional features are intended to enable those skilled in the art to specifically implement various embodiments, and are not intended to limit the scope of the invention. The disclosed terms and phrases are intended to easily describe the various features of the disclosed invention, and are not intended to limit the scope of the invention.

In describing the present disclosure, when it is determined that a detailed description of a related known technology may unnecessarily obscure the gist of the present disclosure, the detailed description is omitted.

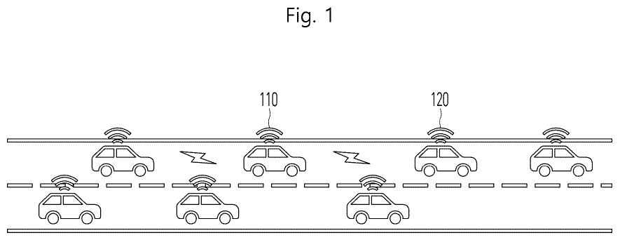

FIG. 1 is a diagram disclosing an example of an adaptive DENM retransmission system according to an embodiment.

In the illustrated example, the adaptive DENM retransmission system may include a plurality of vehicles. In one embodiment, the vehicles may include autonomous vehicles. In one embodiment, the plurality of vehicles may include a transmission user equipment (UE) 110 that transmits a message and a reception user equipment (UE) 120 that receives the message.

In one embodiment, each transmission UE 110 may transmit a periodic message or an aperiodic message to each reception UE 120 via a side-link. In one embodiment, when a new message is generated by the transmission UE 110, content of the message may be encapsulated in a TB (Transport Block) and transmitted together with SCI (dedicated Side-link Control Information).

In this case, when the transmission UE 110 generates a periodic message, that is, a CAM, which is traffic, resources may be reserved using an SB-SPS scheme, and when the transmission UE 110 generates a DENM, which is an aperiodic message, resources of the corresponding message may be reserved using a DS scheme.

In this instance, the DENM contains important information for vehicle safety services, and thus may require high reliability, that is, high PDR performance. Accordingly, the DENM may be retransmitted to increase the PDR of the DENM containing hazard information of a road. However, communication performance may deteriorate due to a phenomenon in which resource collisions increase due to characteristics of a mixed traffic environment of periodic messages and aperiodic messages. Therefore, according to the present disclosure, it is possible to use an adaptive DENM retransmission (ADR) scheme to solve the problem of resource collisions occurring in the NR V2X-based mixed traffic environment. The ADR scheme according to the present disclosure may adaptively adjust reservation of retransmission resources of the DENM based on channel congestion estimated by the transmission UE 110. In one embodiment, the channel congestion may include a channel busy ratio (CBR).

In one embodiment, the ADR scheme according to the present disclosure improves the PDRs of the CAM and the DENM in an environment having high vehicle density, and this result may improve performance of V2X communication through optimization of resource allocation according to real-time channel conditions.

In one embodiment, in a resource allocation scheme for direct communication between the transmission UE 110 and the reception UE 120 via a side-link, the transmission UE 110 may reserve a subchannel for message transmission by itself. That is, it is possible to use the resource allocation scheme for the transmission UE 110 to directly select a side-link resource without support from network infrastructure.

In one embodiment, the transmission UE 110 may perform resource reservation by selecting the SB-SPS scheme or the DS scheme according to the characteristics of the message. These two schemes have in common that the schemes detect whether wireless channel resources are in use and reserve resources estimated to be unused, and have a difference in that the SB-SPS scheme continuously transmits messages generated during a specific time using the same resources, while the DS scheme transmits messages using new resources each time a message is generated.

In one embodiment, a message transmitted by the transmission UE 110 to the reception UE 120 may include at least one of a periodic message and an aperiodic message. For example, the periodic message may include a CAM, and the aperiodic message may include a DENM. In one embodiment, the periodic message may include state information of the transmission UE 110 such as a current speed and position. In addition, the aperiodic message is a message generated due to a specific event, and may include information on an unexpected situation on a road or an abnormal state of a vehicle.

According to the present disclosure, in order to reduce the resource collision phenomenon caused by indiscriminate retransmission of the aperiodic message, resources may be reserved by adaptively adjusting the number of retransmissions of an aperiodic message according to channel congestion estimated by the transmission UE 110 transmitting the aperiodic message.

In addition, according to the present disclosure, it is possible to use a hybrid resource reservation scheme in which resources of aperiodic messages to be retransmitted are reserved by utilizing the DS scheme that is advantageous for retransmission technique for aperiodic messages, and resources are reserved using the SB-SPS scheme in the case of periodic messages.

Therefore, according to the present disclosure, it can be confirmed that, in an environment having high vehicle density, PDR performance of periodic messages and aperiodic messages increases, and a range of transmission and reception distances increases.

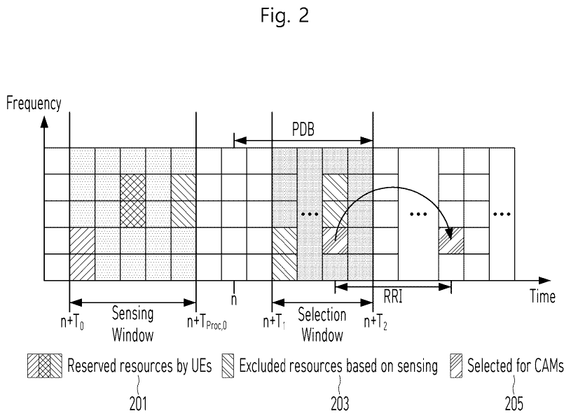

FIG. 2 is a diagram disclosing an example of resource reselection for the CAM using the SB-SPS scheme according to an embodiment.

Referring to FIG. 2, the SB-SPS scheme may include a scheme in which a subchannel is reserved so that the transmission UE 110 periodically transmits a message CAM for a certain period of time. In this case, it is possible to use a parameter referred to as a reselection counter (RC), which indicates the number of times that the reserved subchannel is used. In this instance, the RC may be decremented by 1 for each message transmission.

When the RC is decremented to 0 due to transmission, the transmission UE 110 may reselect a new subchannel with a probability of 1-P. Here, P is a probability of continuing to use the existing subchannel and may be preset in a specific range (for example, [0, 0.8]).

In one embodiment, the transmission UE 110 may decode pieces of SCI received from other UEs during a sensing window, measure reference signal received power (RSRP) thereof, and remove a subchannel 201 reserved by another UE or a subchannel whose RSRP measurement value exceeds an RSRP threshold from a candidate resource group. That is, a subchannel 203 to be removed from the candidate resource group may be determined.

In one embodiment, when the transmission UE 110 selects a new subchannel 205 to transmit a message from the candidate resource group reflecting removal, if the CAM is generated in an nth slot, a selection window including a resource within a range of [n+T₁, n+T₂] may be defined.

That is, the transmission UE 110 may select the new subchannel 205 to transmit a message from the candidate resource group reflecting removal during the selection window. In one embodiment, a value of T₂ may be included in a range of T₂ₘᵢₙ≤T₂≤PDB Here, a packet delay budget (PDB) denotes a maximum delay range of a message, and T₂ min may be determined as in <Mathematical Formula 1> according to SCS (SubCarrier Spacing).

$${T}_{2 min} = \{ 1 , 5 , 10 , 20 \} * {2}^{μ} \qquad [ Mathematical Formula 1 ]$$

$$Here , μ may be μ = \{ 0 , 1 , 2 , 3 \} .$$

Thereafter, the transmission UE 110 randomly select the subchannel 205 to be used for message transmission from the selected candidate resource group and reserve the corresponding subchannel 205. In one embodiment, in the case of a CAM having an RRI (Resource Reservation Interval) of 100 ms, an RC value may be set to a randomly selected value in a range of [5, 15].

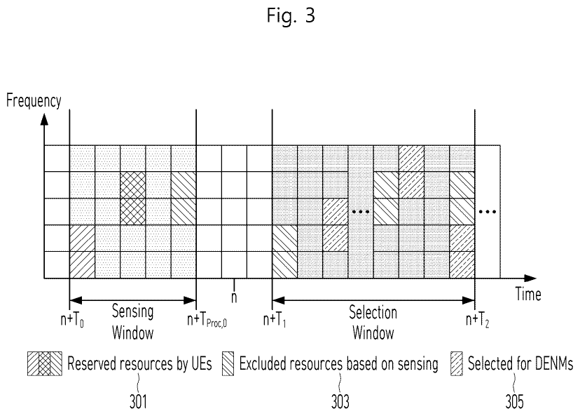

FIG. 3 is a diagram disclosing an example of resource reselection for the DENM using the DS scheme according to an embodiment.

Referring to FIG. 3, a process in which the selection window is defined in the DS scheme, and a subchannel to be used for transmission is selected from a candidate resource group selected based on information (for example, SCI received from another UE) sensed within the sensing window may be the same as the SB-SPS scheme. However, the DS scheme may be different from the SB-SPS scheme in that a new subchannel is selected each time a TB is generated. That is the DS scheme may correspond to the SB-SPS scheme in which the RC is 1 and P is set to 0.

That is, the transmission UE 110 may decode pieces of SCI received from other UEs during the sensing window, measure RSRP for the same, and remove a subchannel 301 reserved by another UE or a subchannel whose RSRP measurement value exceeds the RSRP threshold from the candidate resource group. That is, a subchannel 303 to be the candidate be removed from resource group may determined. In one embodiment, the transmission UE 110 may select a new subchannel 305 to transmit a message from the candidate resource group reflecting removal during the selection window.

The DENM contains important information for vehicle safety services, and thus may require high reliability, that is, high PDR performance. In one embodiment, DENM retransmission and maximal ratio combining (MRC) reception techniques may be used through blind retransmission to increase the performance of the DENM.

In one embodiment, resources may be reserved using the DS scheme to reserve resources for the DENM, which is a retransmitted aperiodic message. For example, when a total of three DENMs is transmitted, in the case of the DENM retransmission technique, simultaneously with reservation of a subchannel of a first DENM, subchannels for the two additional remaining retransmissions of the DENMs may be reserved.

The transmission UE 110 may retransmit the DENM to the reception UE 120 a predetermined number of times. The reception UE 120 may receive the DENM through an MRC process. In one embodiment, the MRC process may be performed based on an average reception SINR (Signal-to-Interference-plus-Noise Ratio) for the DENM transmitted in a t-time slot. For example, an SINR value may be determined as in <Mathematical Formula 2>.

$${γ}_{i , j} ( t ) = \frac{{h}_{i , j} ( t ) {P}_{i} ( t ) / L ( {d}_{i , j} )}{{P}_{n} + {I}_{i , j} ( t )} \qquad [ Mathematical Formula 2 ]$$

Here, γ_{i,j}(t) denotes an average reception SINR value for the DENM, i denotes the transmission UE 110, j denotes the reception UE 120, t denotes a transmission and retransmission time slot, Pᵢ(t) denotes transmission power of i, L(dᵢⱼ) denotes path loss according to a distance between i and j, Pₙ denotes noise power, and I_{i,j}(t) denotes average interference.

In one embodiment, the reception UE 120 may perform the MRC process based on <Mathematical Formula 3> for Q received messages, that is, DENMS. In this instance, successful message reception may be determined such that reception is successful when the SINR by MRC, that is, SINR_{i,j}^{MRC}, exceeds an SINR threshold. In one embodiment, the SINR threshold may be determined according to a used modulation coding scheme (MCS) and a packet size.

$${SINR}_{i , j}^{MRC} = {\sum }_{q = 1}^{Q} {γ}_{i , j} ( {t}_{q} ) \qquad [ Mathematical Formula 3 ]$$

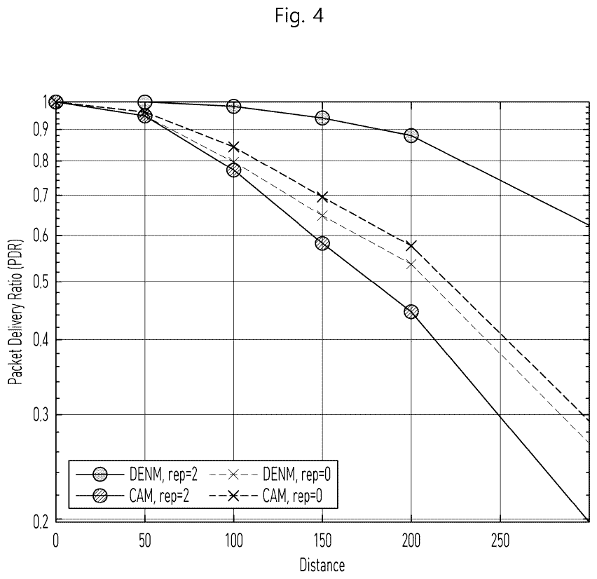

FIG. 4 is a diagram disclosing an example of a performance graph of the DENM and the CAM based on the number of retransmissions of the DENM according to an embodiment.

Referring to FIG. 4, performance of the DENM and the CAM may be verified at a density of 200 vehicles/km in the cases where 80% of all UEs transmit CAMs, the remaining 20% UEs transmit DENMs once, and the remaining 20% UEs transmit DENMS a total of three times, including initial transmission and two retransmissions.

In the performance graph of the DENM and the CAM, an x-axis represents a distance between the transmission UE 110 and the reception UE 120, and a y-axis may represent an average PDR. Here, the PDR is a ratio of correctly decoded messages to transmitted messages, and a higher PDR may mean that reliability of communication increases.

In this way, it can be seen that performance is significantly better when the DENM is retransmitted than when the DENM is not retransmitted, while PDR performance of the CAM is rather lowered when the DENM is retransmitted.

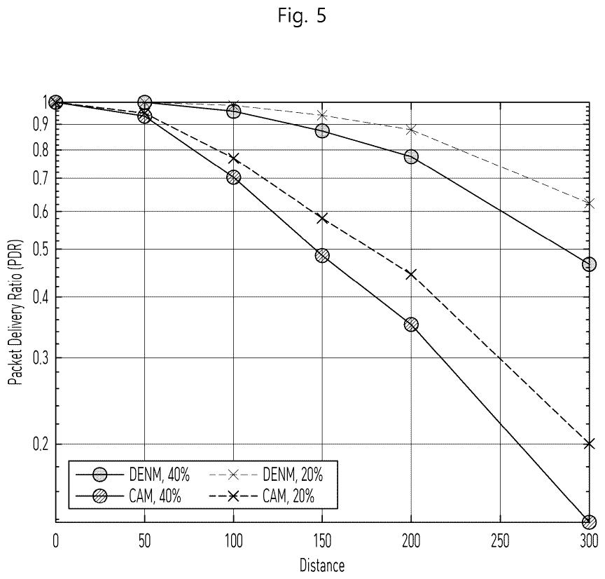

FIG. 5 is a diagram disclosing an example of a PDR performance graph of the DENM and the CAM based on DENM retransmission terminal density according to an embodiment.

Referring to FIG. 5, performance degradation of the CAM due to retransmission the DENM may be further aggravated as the ratio of retransmitting DENMs increases. In this case, PDR performance may be verified at a vehicle density of 200 vehicles/km in the cases where 40% of all UEs retransmit DENMs and when 20% of UEs retransmit DENMs. It can be seen that performances of both the DENM and the CAM deteriorate as the ratio of UEs transmitting DENMS increases. In this situation where periodic messages and aperiodic messages are mixed, as a subchannel is reserved using the DS scheme, and a ratio of retransmitted aperiodic messages increases, a process of reselecting a new subchannel becomes more frequent, and a probability that a plurality of UEs simultaneously selects the same subchannel may increase.

This increases a collision probability between periodic messages and aperiodic messages during transmission, thereby reducing the PDRs of both periodic messages and aperiodic messages. This phenomenon may be aggravated as the density of DENMs increases and channel congestion increases. Therefore, according to the present disclosure, a technology may be used to improve performance of aperiodic messages while minimizing performance degradation of periodic messages by adaptively controlling retransmission of aperiodic messages according to channel congestion.

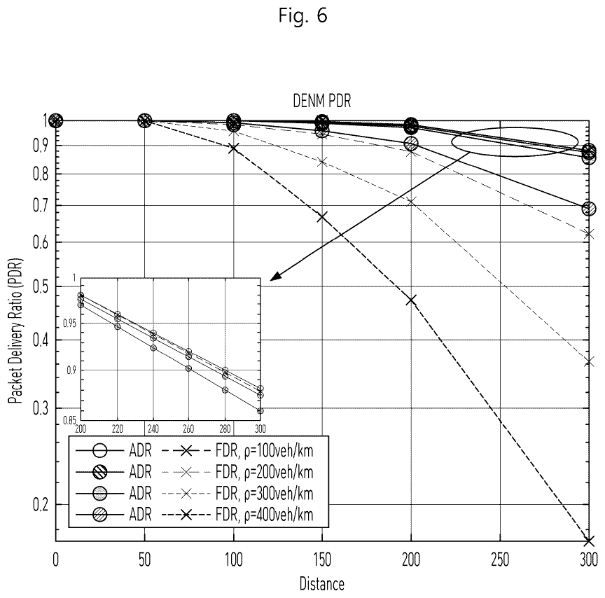

FIG. 6 is a diagram disclosing an example of a PDR performance graph of the DENM for adaptive DENM retransmission and fixed DENM retransmission according to an embodiment.

Referring to FIG. 6, according to the present disclosure, implementation of a communication environment of 5G NR V2X and analysis of MAC layer performance may be performed, and a simulation environment for such analysis in which PHY and MAC layers of NR V2X are implemented may be designed focusing on resource allocation performance analysis of Mode 2.

For example, it is possible to consider a highway environment in which a total of six lanes is included in both defined highway directions and each lane is 4 m wide. In this case, a vehicle speed is set as a Gaussian random variable having a mean of 70 km/h and a standard deviation of 3 km/h, and various vehicle densities may be considered.

In one embodiment, <Table 1> shows a simulation environment and parameters. 20% of all UEs may aperiodically generate DENMs, and the remaining UEs may generate CAMs at intervals of 100 ms. Packet sizes of the CAM and the DENM may be the same, 300 bytes.

TABLE 1

| Parameter | Value | |
|---|---|---|
| Frequency | 5.9 | GHz |
| Channel Bandwidth | 10 | MHz |
| Slot duration | 1 | ms |
| SCS | 15 | kHz |
| CAM periodicity | 100 | ms |
| DENM density | 20% | |
| CAM, DENM size | 300 | bytes |
| MCS index | 7 | |
| Sensing Window | 1,100 | ms |
| Vehicle density | 100, 200, 300, 400 | |
| (ρ) | vehicles/km | |
| Road length | 2 | km |
| Channel model | WINNER II, B1 | |
| Transmission power | 23 | dBm |
| Noise figure | 9 | dB |
| Antenna gain (Tx, Rx) | 3 | dB |
| SINR threshold | 4.35 | dB |
| RSSI threshold | −94 | dBm |
| Simulation time | 30 | s |

In one embodiment, in various vehicle density environments of 100, 200, 300, and 400 vehicles/km, PDR performance of the DENM may be verified when applying a Fixed DENM Retransmission (FDR) scheme of initially transmitting a DENM and additionally retransmitting DENMs a fixed number of times, specifically twice, and the ADR scheme according to the present disclosure.

In this case, as the vehicle density increases, wireless channel congestion increases, significantly degrading PDR performance of the DENM using the FDR. However, when the ADR according to the present disclosure is applied, it can be confirmed that a decrease in PDR performance due to an increase in wireless channel congestion is significantly reduced compared to the FDR. In particular, in terms of a transmissible distance that ensures a PDR of 90% or more of the DENM, the transmissible distance in the ADR is about 100 m longer than in the FDR when the vehicle density is 400 vehicles/km, the transmissible distance in the ADR is about 125 m longer than in the FDR when the vehicle density is 300 vehicles/km, and the transmissible distance in the ADR is about 150 m longer than in the FDR when the vehicle density is 200 vehicles/km.

Since the DENM, which contains information on road emergencies such as traffic accidents and construction, plays an important role in traffic safety, increasing the transmission distance of the DENM is significantly important. In this regard, it can be confirmed that the transmissible distance of the DENM is greatly increased compared to the existing FDR at various congestion levels when the ADR scheme according to the present disclosure is applied.

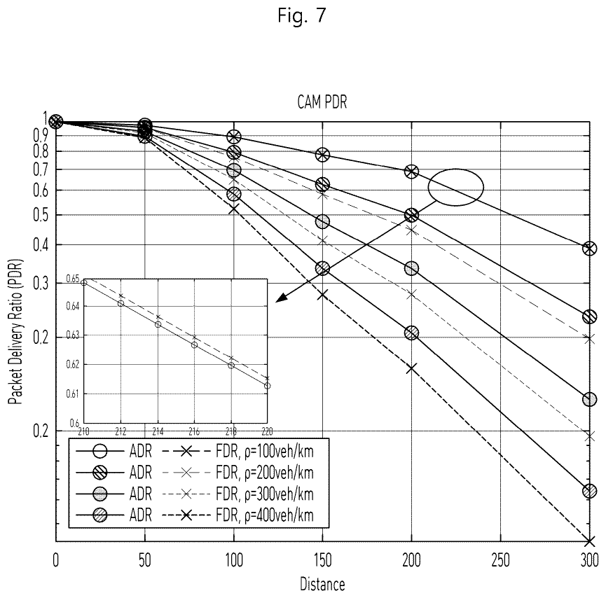

FIG. 7 is a diagram disclosing an example of a PDR performance graph of the CAM for adaptive DENM retransmission and fixed DENM retransmission according to an embodiment.

Referring to FIG. 7, PDR performance of the CAM may be verified in various vehicle density environments of 100, 200, 300, and 400 vehicles/km when applying the FDR scheme of initially transmitting a DENM and additionally retransmitting DENMs a fixed number of times, specifically twice, and the ADR scheme according to the present disclosure.

In this case, it is possible to verify an influence of the ADR scheme according to the present disclosure on PDR performance of the CAM. An increase in vehicle density and a subsequent increase in wireless channel congestion may increase a probability of packet collision with the CAM during a process of selecting resources in the DS of the DENM, thereby degrading PDR performance of the CAM. However, it may be confirmed that PDR performance of the CAM is superior to the case where the FDR is applied even when the vehicle density increases when the ADR according to the present disclosure is applied.

In one embodiment, <Table 2> represents a degree of PDR performance improvement of the ADR scheme compared to the FDR scheme according to the vehicle density based on a transmission distance of 150 m. It may be confirmed that, as the vehicle density increases, performance improvement of the ADR scheme according to the present disclosure increases in both the DENM and the CAM. A reason therefor is that, as wireless channel congestion increases, adjustment of the number of retransmissions according to channel congestion in the ADR scheme more effectively reduces packet collisions between the DENM and the CAM.

TABLE 2

| msg | DENM | | | CAM | | |
|---|---|---|---|---|---|---|
| rho | ADR | FDR | % | ADR | FDR | % |
| 400 | 0.9575 | 0.6677 | +43.40 | 0.3353 | 0.2759 | +21.52 |
| 300 | 0.9881 | 0.8412 | +17.47 | 0.4756 | 0.4128 | +15.22 |
| 200 | 0.9904 | 0.9419 | +5.15 | 0.6248 | 0.5790 | +7.92 |
| 100 | 0.9925 | 0.9921 | −0.03 | 0.7805 | 0.7821 | −0.20 |

According to the present disclosure, mixed traffic, in which the DENM corresponding to aperiodic traffic and the CAM corresponding to periodic traffic are mixed, is designed in an NR V2X environment, and in order to solve a problem that an increase in aperiodic traffic causes collision between resource reservations, degrading communication performance, it is possible to use the ADR scheme that adaptively adjusts the number of retransmissions of the DENM by estimating a CBR indicating a channel congestion state.

It may be confirmed that the ADR scheme according to the present disclosure has an effect of expanding a transmission and reception range of messages by reducing a phenomenon of resource collisions increased due to indiscriminate repetitive DENM transmission. In addition, it may be confirmed that the PDR of the message increases as channel congestion increases.

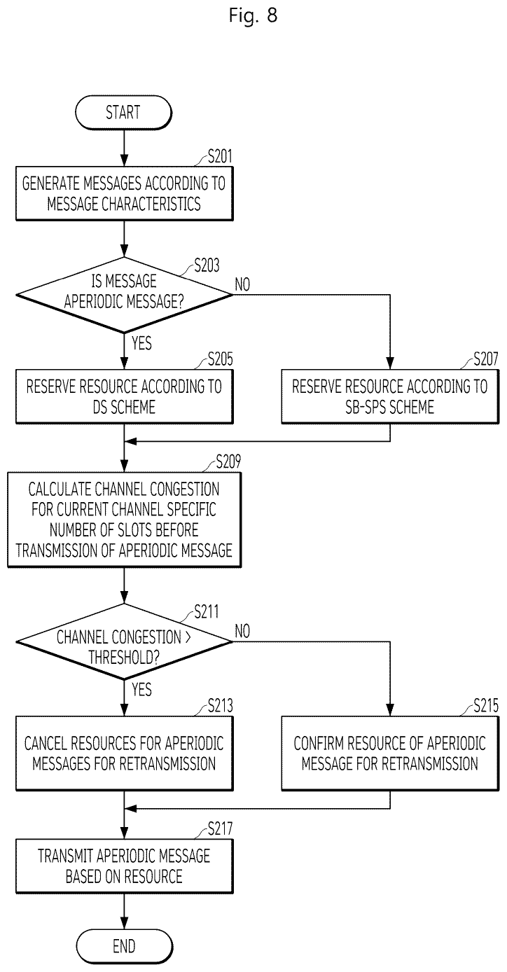

FIG. 8 is a flowchart disclosing an example of an adaptive DENM retransmission method according to an embodiment.

Referring to FIG. 8, according to the present disclosure, the ADR scheme that adaptively adjusts the number of retransmissions of DENMs using channel congestion to reserve resources may be used to relieve degradation of communication performance due to resource collision caused by excessive retransmission of DENMs.

A plurality of messages is generated according to message characteristics (S201). In one embodiment, in a mixed traffic environment where aperiodic messages and periodic messages are transmitted and received through a plurality of UEs, a resource reservation scheme of messages may be used, and different resource reservation schemes may be applied according to the characteristics of the messages. This is described in detail below.

It is determined whether each of the plurality of generated messages is an aperiodic message or a periodic message (S203). In one embodiment, the aperiodic message may include the DENM, and the periodic message may include the CAM.

When the plurality of generated messages is aperiodic messages, resources for the aperiodic messages are reserved according to the DS scheme (S205). In one embodiment, when DENMs are generated, subchannels of aperiodic messages to be retransmitted may be simultaneously reserved according to the DS scheme.

When the generated messages are periodic messages, resources for the periodic messages are reserved according to the SB-SPS scheme (S207). In one embodiment, when a CAM is generated, a subchannel may be reserved according to the SP-SPS scheme.

Channel congestion for a current channel a specific number of slots before transmission of an aperiodic message is calculated (S209). In one embodiment, the channel congestion may include a CBR. Here, the CBR may represent a ratio of channels occupied by other UEs a specific number (for example, 100×2^{μ}) of slots ago. Here, when a received signal strength indicator (RSSI) of a corresponding resource is greater than an RSSI threshold, it may be determined that the corresponding resource is occupied. That is, the channel congestion CBR may be determined based on the RSSI for the corresponding resource. In one embodiment, a transmission UE reserving resources for aperiodic messages may estimate the CBR of the current channel three slots before transmission of a first aperiodic message that it has reserved.

It is determined whether channel congestion is greater than a congestion threshold (S211). In one embodiment, it may be determined whether channel congestion is greater than a first congestion threshold. In addition, when channel congestion is greater than the first congestion threshold, it may be determined whether channel congestion is greater than a second congestion threshold that is greater than the first congestion threshold. For example, the congestion threshold may be set as shown in <Table 3>, but is not limited thereto and may be set in various ways. For example, the first congestion threshold may be 0.65, and the second congestion threshold may be 0.99.

TABLE 3

| CBR measured | Cancellation of DENM |
|---|---|
| 0 ≤ CBR < 0.65 | 0 |
| 0.65 ≤ CBR < 0.99 | 1 |
| 0.99 ≤ CBR | 2 |

In one embodiment, at least one congestion threshold may be adaptively adjusted according to a current vehicle density in a mixed traffic environment. In one embodiment, a machine learning technique may be applied to learn channel congestion that varies according to various vehicle densities, and the number of retransmissions of an aperiodic message may be adaptively adjusted based on a learned result. In one embodiment, the first congestion threshold may be adjusted when the current vehicle density is less than the density threshold, and the second congestion threshold may be adjusted when the current vehicle density is greater than the density threshold. In one embodiment, at least one congestion threshold may be adjusted in response to a variation in channel congestion that varies according to the current vehicle density. In one embodiment, the at least one congestion threshold may be finely adjusted by applying, as a weight, a ratio of UEs transmitting periodic messages and UEs transmitting aperiodic messages according to the current vehicle density to the at least one congestion threshold adaptively adjusted according to the current vehicle density.

When channel congestion is greater than the congestion threshold, resources for aperiodic messages for retransmission are canceled according to the channel congestion (S213). In one embodiment, when the calculated channel congestion is greater than the congestion threshold, resource reservation for aperiodic messages for retransmission may be canceled.

For example, an aperiodic message for initial transmission and two aperiodic messages for retransmission may be generated. In this instance, when channel congestion for the current channel of the corresponding aperiodic message is greater than the first congestion threshold (for example, 0.65) and less than the second congestion threshold (for example, 0.99), resource reservation of the aperiodic message to be retransmitted last is canceled once, and resources for the two aperiodic messages are reserved. Finally, when the channel congestion is greater than the second congestion threshold (for 0.99), resource reservation example, for retransmission of the second and third aperiodic messages is canceled, and a resource for only one aperiodic message may be reserved.

According to the present disclosure, the number of retransmissions of an aperiodic message may be adaptively adjusted according to a channel congestion state by adaptively canceling subchannels reserved for retransmission according to the measured channel congestion.

When channel congestion is not greater than the congestion threshold, a resource of an aperiodic message for retransmission is determined (S215). In one embodiment, resource reservation of previously reserved resources of the aperiodic message for retransmission may be confirmed. For example, when channel congestion is less than the first congestion threshold (for example, 0.65), the current state of the channel is determined to be not congested, and thus resource reservation of the aperiodic message for retransmission may be transmitted all three times without canceling.

Based on the resource, the aperiodic message is transmitted to the reception UE 120 (S217). In one embodiment, each step of FIG. 8 may be performed by the transmission UE 110. In one embodiment, the respective steps of FIG. 8 may be performed simultaneously, sequentially, or in reverse order, and at least one step may be omitted.

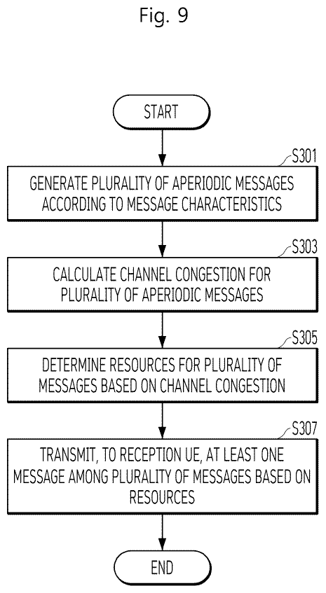

FIG. 9 is a flowchart disclosing another example of an adaptive DENM retransmission method according to an embodiment.

Referring to FIG. 9, a plurality of aperiodic messages is generated according to message characteristics (S301). In one embodiment, prior to step S303, resources for the plurality of aperiodic messages may be reserved based on the DS scheme that utilizes a new resource each time a message is generated. In one embodiment, a plurality of periodic messages may be generated according to message characteristics. In this case, resources for the plurality of periodic messages may be reserved based on the SB-SPS scheme that utilizes the same resources for messages generated during a specific time.

Channel congestion for the plurality of aperiodic messages is calculated (S303). In one embodiment, channel congestion of the current channel for the plurality of aperiodic messages may be calculated a specific number of slots before transmission of a first aperiodic message among the plurality of aperiodic messages.

Resources for the plurality of messages are determined based on channel congestion (S305). In one embodiment, resources for at least one message among the plurality of messages may be reserved based on channel congestion, and resources for the remaining messages except for the at least one message among the plurality of messages may be cancelled.

At least one of the plurality of messages is transmitted to the reception UE 120 based on the resources (S307). In one embodiment, based on the resources, a first message among the at least one message may be transmitted to the reception UE 120, and the remaining messages may be retransmitted.

In one embodiment, each step of FIG. 9 may be performed by the transmission UE 110. In one embodiment, the respective steps of FIG. 9 may be performed simultaneously, sequentially, or in reverse order, and at least one step may be omitted.

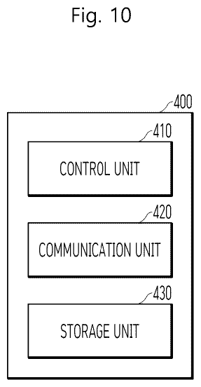

FIG. 10 is a diagram disclosing an example of an adaptive DENM retransmission apparatus according to an embodiment.

Referring to FIG. 10, the adaptive DENM retransmission apparatus 400 may include a control unit 410, a communication unit 420, and a storage unit 430. In one embodiment, the adaptive DENM retransmission apparatus 400 may include the transmission UE 110.

The control unit 410 may generate a plurality of aperiodic messages according to message characteristics, calculate channel congestion for the plurality of generated aperiodic messages, and determine resources for the plurality of messages based on the channel congestion.

In one embodiment, the control unit 410 may include at least one processor or microprocessor, or may be a part of a processor. In addition, the control unit 410 may be referred to as a communication processor (CP). The control unit 410 may control an operation of the adaptive DENM retransmission apparatus 400 according to various embodiments of the present disclosure by using at least one of the communication unit 420 or the storage unit 430.

The communication unit 420 may transmit at least one message among the plurality of messages to the reception UE 120 based on the resources. In one embodiment, the communication unit 420 may include at least one of a wired communication module or a wireless communication module. All or part of the communication unit 420 may be referred to as a “transmitter”, a “receiver”, or a “transceiver”.

The storage 430 may store least one of an aperiodic message or a periodic message. In addition, the storage 430 may store channel congestion calculated for the aperiodic message and a congestion threshold compared therewith. In one embodiment, the storage 430 may include a volatile memory, a nonvolatile memory, or a combination of the volatile memory and the nonvolatile memory. In addition, the storage 430 may provide stored data according to a request from the control unit 410. In one embodiment, the storage 430 may include a storage medium storing a computer-executable program that performs adaptive DENM retransmission.

Referring to FIG. 10, the adaptive DENM retransmission apparatus 400 may include the control unit 410, the communication unit 420, and the storage unit 430. In various embodiments of the present disclosure, the adaptive DENM retransmission apparatus 400 may be implemented to have more or fewer components than the components described in FIG. 10 since the components described in FIG. 10 are not essential.

According to the disclosed embodiments, the PDRs of the CAM and the DENM may be improved in an environment having high vehicle density using the ADR scheme.

In addition, according to the disclosed embodiments, performance of V2X communication may be improved through optimization of resource allocation according to real-time channel conditions.

The above description is merely an example of the technical idea of the present disclosure, and those skilled in the art will be able to make various changes and modifications without departing from the essential characteristics of the present disclosure.

Therefore, the embodiments disclosed in this specification are not intended to limit the technical idea of the present disclosure, but to describe the technical idea, and the scope of the present disclosure is not limited by these embodiments. The protection scope of the present disclosure should be interpreted by the claims, and all technical ideas within the equivalent scope should be understood to be included in the scope of the rights of the present disclosure.

What is claimed is:

1. A method for adaptive retransmission of a decentralized environmental message (DENM) based on 5G new radio (NR) Vehicle to Everything (V2X), the method comprising:
generating a plurality of aperiodic messages according to message characteristics;
calculating channel congestion for the plurality of generated aperiodic messages;
determining resources for the plurality of messages based on the channel congestion; and
transmitting, to a reception user equipment (UE), at least one message among the plurality of messages based on the resources.

2. The method according to claim 1, further comprising reserving resources for the plurality of aperiodic messages based on a dynamic scheduling (DS) scheme using a new resource each time a message is generated before the calculating.

3. The method according to claim 1, wherein the calculating comprises calculating channel congestion of a current channel for the plurality of aperiodic messages a specific number of slots before transmission of a first aperiodic message among the plurality of aperiodic messages.

4. The method according to claim 1, wherein the determining comprises reserving a resource for at least one message among the plurality of messages according to the channel congestion, and canceling resources for remaining messages except for the at least one message among the plurality of messages.

5. An apparatus for adaptive retransmission of a DENM based on 5G NR V2X, the apparatus comprising:
a database configured to store data; and
a processor configured to process the data,
wherein the processor is configured to:
generate a plurality of aperiodic messages according to message characteristics;
calculate channel congestion for the plurality of generated aperiodic messages;
determine resources for the plurality of messages based on the channel congestion; and
transmit, to a reception UE, at least one message among the plurality of messages based on the resources.

6. The apparatus according to claim 5, wherein the processor reserves resources for the plurality of aperiodic messages based on a DS scheme using a new resource each time a message is generated.

7. The apparatus according to claim 5, wherein the processor calculates channel congestion of a current channel for the plurality of aperiodic messages a specific number of slots before transmission of a first aperiodic message among the plurality of aperiodic messages.

8. The apparatus according to claim 5, wherein the processor reserves a resource for at least one message among the plurality of messages according to the channel congestion, and cancels resources for remaining messages except for the at least one message among the plurality of messages.

9. A storage medium storing a computer-executable program configured to perform steps of:
generating a plurality of aperiodic messages according to message characteristics;
calculating channel congestion for the plurality of generated aperiodic messages;
determining resources for the plurality of messages based on the channel congestion; and
transmitting, to a reception UE, at least one message among the plurality of messages based on the resources.
